(19) United States
(12) Patent Application Publication
(10) Pub. No.: US 2026/0005303 A1
(43) Pub. Date: Jan. 1, 2026

(54) COMPOUND, ELECTROLYTE FOR RECHARGEABLE LITHIUM BATTERY INCLUDING THE SAME, AND RECHARGEABLE LITHIUM BATTERY INCLUDING THE SAME

(71) Applicant: SAMSUNG SDI CO., LTD., Yongin-si (KR)

(72) Inventors: Euisoo JEONG, Yongin-si (KR); SUNDAE KIM, Yongin-si (KR); JIN-HYEOK LIM, Yongin-si (KR); JINAH SEO, Yongin-si (KR); Erang CHO, Yongin-si (KR); Sujeong KOH, Yongin-si (KR); Bomee KWON, Yongin-si (KR); SANGHOON KIM, Yongin-si (KR)

(21) Appl. No.: 19/093,071

(22) Filed: Mar. 27, 2025

(30) Foreign Application Priority Data
Jun. 27, 2024 (KR) 10-2024-0084289

(51) Int. Cl. H01M 10/0567; H01M 4/02; H01M 4/131; H01M 4/36; H01M 4/38; H01M 4/525; H01M 4/583; H01M 10/052; H01M 10/0568; H01M 10/0569

(52) U.S. Cl. CPC H01M 10/0567; H01M 4/131; H01M 4/364; H01M 4/386; H01M 4/525; H01M 4/583; H01M 10/052; H01M 10/0568; H01M 10/0569; H01M 2004/027; H01M 2004/028; H01M 2300/004; H01M 2300/0051

(57) ABSTRACT

A compound, an electrolyte including the compound, and a rechargeable lithium battery including the electrolyte are provided. The electrolyte includes: a non-aqueous organic solvent; a lithium salt; and an additive. The additive includes the compound that is represented by Chemical Formula 1.

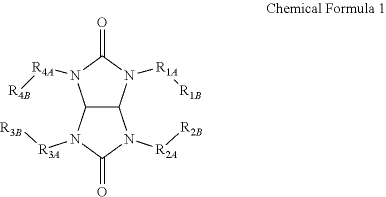

### CROSS-REFERENCE TO RELATED APPLICATION

The present application claims priority to and the benefit of Korean Patent Application No. 10-2024-0084289, filed on Jun. 27, 2024, in the Korean Intellectual Property Office, the entire disclosure of which is incorporated herein by reference.

### BACKGROUND

### 1. Field

One or more embodiments of the present disclosure relate to a compound, an electrolyte for a rechargeable lithium battery including the compound, and a rechargeable lithium battery including the electrolyte.

### 2. Description of the Related Art

Recently, with the rapid spread and popularization of battery-powered electronic devices (such as mobile phones, laptop computers) as well as electric vehicles that use batteries, the demand for such batteries, e.g., rechargeable batteries, with relatively high energy density and high capacity has been rapidly increasing. Therefore, intensive research has been conducted to improve performance of such rechargeable batteries, e.g., rechargeable lithium batteries.

A rechargeable lithium battery includes a positive electrode, a negative electrode, and an electrolyte. The positive and negative electrodes each include an active material capable of intercalation and deintercalation of lithium ions, generating electrical energy through oxidation and reduction reactions when lithium ions are intercalated and deintercalated. For example, the electrical energy is generated when lithium ions are intercalated into the positive electrode and/or deintercalated from the negative electrode during the discharge process.

A lithium salt dissolved in a non-aqueous organic solvent is generally used as the electrolyte of the rechargeable lithium battery. The characteristics of the rechargeable lithium battery are achieved through complex reactions between the positive electrode and the electrolyte as well as between the negative electrode and the electrolyte. Accordingly, the use of an appropriate or suitable electrolyte is an importance variable that may improve the performance of the rechargeable lithium batteries.

### SUMMARY

One or more aspects of embodiments of the present disclosure are directed toward an additive that has an excellent or suitable effect on improving the performance of a rechargeable lithium battery at elevated or high temperatures.

One or more aspects of embodiments of the present disclosure are directed towards a rechargeable lithium battery that exhibits (has) superior performance at high temperatures by including the additive.

Additional aspects will be set forth in part in the description which follows and, in part, will be apparent from the description, or may be learned by practice of the presented embodiments of the disclosure.

According to one or more embodiments of the present disclosure, an electrolyte for a rechargeable lithium battery may include: a non-aqueous organic solvent; a lithium salt; and an additive.

The additive may include a compound represented by Chemical Formula 1.

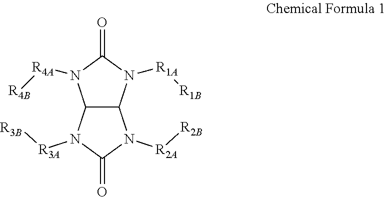

In Chemical Formula 1,

R_{1A}, R_{2A}, R_{3A}, and R_{4A} may each independently be a substituted or unsubstituted C1 to C10 alkylene group, a substituted or unsubstituted C2 to C10 alkenylene group, or a substituted or unsubstituted C2 to C10 alkynylene group.

R_{1B}, R_{2B}, R_{3B}, and R_{4B} may each independently be hydrogen, a substituted or unsubstituted C1 to C10 alkyl group, a substituted or unsubstituted C2 to C10 alkenyl group, or a substituted or unsubstituted C2 to C10 alkynyl group.

At least one selected from among R_{1B}, R_{2B}, R_{3B}, and R_{4B} may include an alkenyl group.

According to one or more embodiments of the present disclosure, the additive may include a compound represented by Chemical Formula 2.

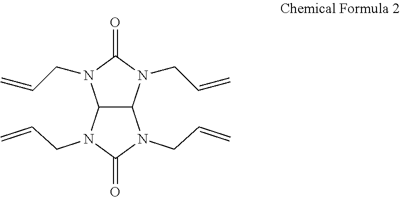 [SMILES: C=CCN1C(=O)N(CC=C)C2C1N(CC=C)C(=O)N2CC=C]

According to one or more embodiments of the present disclosure, a rechargeable lithium battery may include: a positive electrode that includes a positive electrode active material; a negative electrode that includes a negative electrode active material; and the electrolyte as described above.

### BRIEF DESCRIPTION OF DRAWINGS

The accompanying drawings are included to provide a further understanding of the present disclosure, and are incorporated in and constitute a part of this disclosure. The drawings illustrate example embodiments of the present disclosure and, together with the description, serve to explain principles of the present disclosure. The above and other aspects, features, and advantages of certain embodiments of the present disclosure will be more apparent from the following description taken in conjunction with the accompanying drawings.

FIG. 1 illustrates a simplified conceptual diagram showing a rechargeable lithium battery according to one or more embodiments of the present disclosure.

FIGS. 2-5 are each a simplified schematic diagram showing a rechargeable lithium battery according to one or more embodiments of the present disclosure, where FIG. 2 shows a cylindrical battery, FIG. 3 shows a prismatic battery, and FIGS. 4 and 5 each show a pouch-type (kind) battery.

FIG. 6 illustrates a graph showing proton nuclear magnetic resonance (¹H-NMR) spectroscopy results of a compound according to Synthesis Example 1 of the present disclosure.

### DETAILED DESCRIPTION

In order to sufficiently understand the configurations and effects of the present disclosure, one or more embodiments of the present disclosure will be described with reference to the accompanying drawings. It should be noted, however, that the present disclosure is not limited to the following example embodiments, and may be implemented in one or more other suitable forms. Rather, the example embodiments are provided only to illustrate the present disclosure and assist those skilled in the art to fully know the scope of the disclosure.

In the present disclosure, it will be understood that, if (e.g., when) an element is referred to as being on another element, the element may be directly on the other element or intervening elements may be present therebetween. In contrast, if (e.g., when) an element is referred to as being “directly on” another element, there are no intervening elements present. In the drawings, thicknesses of some components may be exaggerated for effectively explaining the technical contents. Like reference numerals refer to like elements throughout the present disclosure, and duplicative descriptions thereof may not be provided for conciseness.

Unless otherwise specially noted in the disclosure, the singular forms “a,” “an,” and “the” are intended to include the plural forms as well, unless the context clearly indicates otherwise. Further, the utilization of “may” when describing embodiments of the present disclosure refers to “one or more embodiments of the present disclosure”. In addition, unless otherwise specially noted, the phrase “A or B” or “A and/or B” or “A/B” may indicate “A but not B,” “B but not A,” and “A and B.” The terms “comprise(s)/include(s)” and/or “comprising/including” and/or “have (has)/having” used in the present disclosure do not exclude the presence or addition of one or more other components.

As used herein, the term “combination thereof” may refer to a mixture, a stack, a composite, a copolymer, an alloy, a blend, or a reaction product of the constituents.

Unless otherwise especially defined in the disclosure, a particle diameter may be an average particle diameter. In addition, a particle diameter indicates an average particle diameter (D₅₀) where a cumulative volume is about 50 volume % in a particle size distribution. The average particle diameter (D₅₀) may be measured by a method widely suitable to those skilled in the art, for example, by a particle size analyzer, for example, HORIBA, LA-950 laser particle size analyzer, a transmission electron microscope (TEM), or a scanning electron microscope (SEM). In one or more embodiments, a dynamic light-scattering measurement device is used to perform a data analysis, the number of particles is counted for each particle size range, and then from the collected data, an average particle diameter (D₅₀) value may be obtained through a calculation. In one or more embodiments, a laser scattering method may be utilized to measure the average particle diameter (D₅₀). In the laser scattering method, target particles are distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device. D₅₀ refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size. In the present disclosure, when particles are spherical, “diameter” indicates an average particle diameter, and when the particles are non-spherical, the “diameter” indicates a major axis length.

In the present disclosure, unless otherwise separately defined, the term “substituted” may refer to that at least one hydrogen of a substituent or a compound is substituted by deuterium, a halogen, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, and/or a (e.g., any suitable) combination thereof.

In more detail, the term “substituted” may refer to that at least one hydrogen of a substituent or a compound is substituted by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, in one or more embodiments, the term “substituted” may refer to that at least one hydrogen of a substituent or a compound is substituted by deuterium, a halogen, a C1 to C20 alkyl group, a C6 to C30 aryl group, a C1 to C10 fluoroalkyl group, or a cyano group. In one or more embodiments, the term “substituted” may refer to that at least one hydrogen of a substituent or a compound is substituted by deuterium, a halogen, a C1 to C5 alkyl group, a C6 to C18 aryl group, a C1 to C5 fluoroalkyl group, or a cyano group. For example, in one or more embodiments, the term “substituted” may refer to that at least one hydrogen of a substituent or a compound is substituted by deuterium, a cyano group, a halogen, a methyl group, an ethyl group, a propyl group, a butyl group, a phenyl group, a biphenyl group, a terphenyl group, a trifluoromethyl group, or a naphthyl group. In other words, the term “substituted” may refer to the replacement of at least one hydrogen in a substituent or compound with deuterium, a halogen, a C1 to C5 alkyl group, a C6 to C18 aryl group, a C1 to C5 fluoroalkyl group, or a cyano group. For example, in one or more embodiments, “substituted” may refer to that at least one hydrogen in a substituent or compound is replaced by deuterium, a cyano group, a halogen, a methyl group, an ethyl group, a propyl group, a butyl group, a phenyl group, a biphenyl group, a terphenyl group, a trifluoromethyl group, or a naphthyl group.

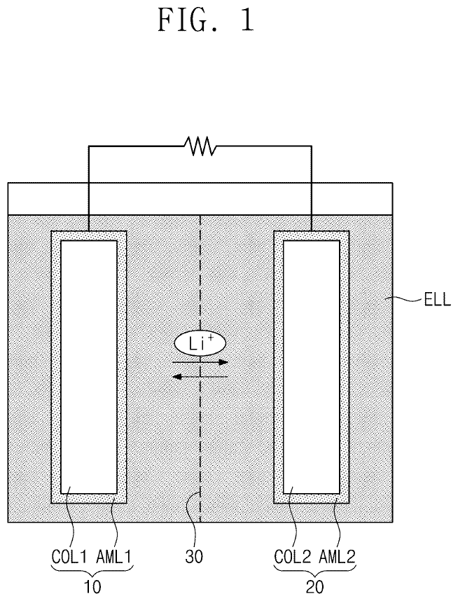

FIG. 1 illustrates a simplified conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. For example, the positive electrode 10, the negative electrode 20, and the separator 30 may be impregnated in and/or with the electrolyte ELL.

The electrolyte ELL may be a medium through which lithium ions are migrated and transferred between the positive electrode 10 and the negative electrode 20. In the electrolyte ELL, the lithium ions may move through the separator 30 toward one selected from among the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML 1 may include a positive electrode active material (e.g., in a form of particles) and may further include a binder and/or a conductive material (e.g., an electron conductor).

An amount of the positive electrode active material may be in a range of about 90 wt % to about 99.5 wt % relative to (i.e., based on) 100 wt % of a total weight of the positive electrode active material layer AML1. An amount of each of the binder and the conductive material may be in a range of about 0.5 wt % to about 5 wt % relative to (i.e., based on) 100 wt % of the total weight of the positive electrode active material layer AML1.

The binder may serve to improve attachment of positive electrode active material particles to each other and also to improve attachment of the positive electrode active material to the current collector COL1. The binder may include, for example, one or more selected from among polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but embodiments of the present disclosure are not limited thereto.

The conductive material (e.g., an electrically or electron conductive material or conductor) may be used to provide an electrode with conductivity, and any suitable conductive material that does not cause a chemical change in a battery may be used as the conductive material. The conductive material may include, for example, a carbon-based material such as natural graphite, artificial graphite, carbon black, acetylene black, Ketjen black, carbon fiber, carbon nano-fiber, and/or carbon nano-tube; a metal powder or metal fiber containing one or more selected from among copper, nickel, aluminum, and silver; a conductive polymer such as a polyphenylene derivative; and/or a (e.g., any suitable) mixture thereof.

In one or more embodiments, aluminum (Al) may be used as the current collector COL1, but embodiments of the present disclosure are not limited thereto.

### Positive Electrode Active Material

The positive electrode active material in the positive electrode active material layer AML1 may include a compound (e.g., lithiated intercalation compound) that may reversibly intercalate and deintercalate lithium. For example, in one or more embodiments, the positive electrode active material may include at least one kind of composite oxide including lithium and a metal that is selected from among cobalt, manganese, nickel, and/or a (e.g., any suitable) combination thereof.

The composite oxide may include lithium transition metal composite oxides, for example, lithium-nickel-based oxides, lithium-cobalt-based oxides, lithium-manganese-based oxides, lithium-iron-phosphate-based compounds, cobalt-free nickel-manganese-based oxides, and/or a (e.g., any suitable) combination thereof.

For example, in one or more embodiments, the positive electrode active material may include a compound expressed by one selected from among chemical formulae: LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O₂₋ₐDₐ (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤α≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where O≤f≤2); LiₐFePO₄ (where 0.90≤a≤1.8).

In the foregoing chemical formulae, A may be nickel (Ni), cobalt (Co), manganese (Mn), or a (e.g., any suitable) combination thereof, X may be Al, Ni, Co, Mn, chromium (Cr), iron (Fe), magnesium (Mg), strontium (Sr), vanadium (V), a rare-earth element, or a (e.g., any suitable) combination thereof, D may be oxygen (O), fluorine (F), sulfur(S), phosphorous (P), or a (e.g., any suitable) combination thereof, G may be Al, Cr, Mn, Fe, Mg, lanthanum (La), cerium (Ce), Sr, V, or a (e.g., any suitable) combination thereof, and L¹ may be Mn, Al, or a (e.g., any suitable) combination thereof.

For example, in one or more embodiments, the positive electrode active material may be a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to (i.e., based on) 100 mol % of a total metal excluding lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material (e.g., in a form of particles) and may further include a binder and/or a conductive material (e.g., an electron conductor).

For example, in one or more embodiments, the negative electrode active material layer AML2 may include a negative electrode active material of about 90 wt % to about 99 wt %, a binder of about 0.5 wt % to about 5 wt %, and a conductive material of about 0 wt % to about 5 wt %, based on 100 wt % of a total weight of the negative electrode active material layer.

The binder may serve to improve attachment of negative electrode active material particles to each other and also to improve attachment of the negative electrode active material to the current collector COL2. The binder may include a non-aqueous (e.g., water-insoluble) binder, an aqueous (e.g., water-soluble) binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluoro elastomer, polyethylene oxide, polyvinyl pyrrolidone, polyepichlorohydrin, polyphosphazene, poly (meth)acrylonitrile, an ethylene propylene diene copolymer, polyvinyl pyridine, chlorosulfonated polyethylene, latex, a polyester resin, a (meth)acrylic resin, a phenolic resin, an epoxy resin, polyvinyl alcohol, and/or a (e.g., any suitable) combination thereof.

When an aqueous binder is used as the binder of the negative electrode, a cellulose-based compound capable of providing viscosity may further be included. The cellulose-based compound may include one or more selected from among carboxymethyl cellulose, hydroxypropylmethyl cellulose, methyl cellulose, and alkali metal salts thereof. The alkali metal may include Na, K, or Li.

The dry binder may include a fibrillizable polymer material, for example, polytetrafluoroethylene, polyvinylidene fluoride, a polyvinylidene fluoride-hexafluoropropylene copolymer, polyethylene oxide, and/or a (e.g., any suitable) combination thereof.

The conductive material (e.g., electrically or electron conductive material or conductor) may be used to provide an electrode with conductivity, and any suitable conductive material that does not cause a chemical change in a battery may be used as the conductive material. For example, in one or more embodiments, the conductive material may include a carbon-based material such as natural graphite, artificial graphite, carbon black, acetylene black, Ketjen black, carbon fiber, carbon nano-fiber, and/or carbon nano-tube; a metal powder or metal fiber including one or more selected from among copper, nickel, aluminum, and silver; a conductive polymer such as a polyphenylene derivative; and/or a (e.g., any suitable) mixture thereof.

The current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that may reversibly intercalate and deintercalate lithium ions, lithium metal, a lithium metal alloy, a material that may dope and de-dope lithium, or a transition metal oxide.

The material that may reversibly intercalate and deintercalate lithium ions may include a carbon-based negative electrode active material, for example, crystalline carbon, amorphous carbon, and/or a (e.g., any suitable) combination thereof. For example, the crystalline carbon may include graphite such as non-shaped (e.g., irregularly shaped), sheet-shaped, flake-shaped, sphere-shaped, or fiber-shaped natural graphite and/or artificial graphite, and the amorphous carbon may include soft carbon, hard carbon, mesophase pitch carbon, and/or calcined coke.

The lithium metal alloy may include an alloy of lithium and a metal that is selected from among sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (AI), and tin (Sn).

The material that may dope and de-dope lithium may include a Si-based negative electrode active material or a Sn-based negative electrode active material. The Si-based negative electrode active material may include silicon, a silicon-carbon composite, SiOₓ (where 0<x≤2), a Si-Q alloy (where Q is an alkali metal, an alkaline earth metal, a Group 13 element, a Group 14 element (except for Si), a Group 15 element, a Group 16 element, a transition metal, a rare-earth element, or a (e.g., any suitable) combination thereof), and/or a (e.g., any suitable) combination thereof. The Sn-based negative electrode active material may include Sn, SnOₖ (0<k≤2) (e.g., SnO₂), a Sn-based alloy, or a (e.g., any suitable) combination thereof.

The silicon-carbon composite may be a composite of silicon and amorphous carbon (e.g., in a form of particles). According to one or more embodiments, the silicon-carbon composite may have a structure in which the amorphous carbon is coated on a surface of the silicon particle. For example, in one or more embodiments, the silicon-carbon composite may include a secondary particle (core) in which primary silicon particles are assembled, and an amorphous carbon coating layer (shell) on (e.g., positioned on) a surface of the secondary particle. The amorphous carbon may also be positioned between the primary silicon particles, and for example, the primary silicon particles may be coated with the amorphous carbon. The secondary particles may be present dispersed in an amorphous carbon matrix.

In one or more embodiments, the silicon-carbon composite may further include crystalline carbon. For example, the silicon-carbon composite may include a core including crystalline carbon and silicon particles and may also include an amorphous carbon coating layer on (e.g., positioned on) a surface of the core.

In one or more embodiments, the Si-based negative electrode active material or the Sn-based negative electrode active material may be used in combination with a carbon-based negative electrode active material.

### Separator 30

Based on type (kind) of the rechargeable lithium battery, the separator 30 may be present between the positive electrode 10 and the negative electrode 20. The separator 30 may include one or more selected from among polyethylene, polypropylene, and polyvinylidene fluoride, or may have a multi-layered separator thereof such as a polyethylene/polypropylene bi-layered separator, a polyethylene/polypropylene/polyethylene tri-layered separator, or a polypropylene/polyethylene/polypropylene tri-layered separator.

The separator 30 may include a porous substrate and a coating layer on (e.g., positioned on) a surface (e.g., one surface or two opposite surfaces) of the porous substrate, and the coating layer may include an organic material, an inorganic material, and/or a (e.g., any suitable) combination thereof.

The porous substrate may be a polymer layer including one selected from among polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymers, polyphenylenesulphide, polyethylene naphthalate, glass fibers, and polytetrafluoroethylene (e.g., Teflon), or may be a copolymer or a mixture including two or more thereof.

The organic material may include a polyvinylidenefluoride-based copolymer and/or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, and/or a (e.g., any suitable) combination thereof, but embodiments of the present disclosure are not limited thereto.

In one or more embodiments, the organic material and the inorganic material may be present mixed in one coating layer or may be present as a stack of a coating layer including the organic material and a coating layer including an inorganic material.

### Electrolyte ELL

The electrolyte ELL for the rechargeable lithium battery may include a non-aqueous organic solvent and a lithium salt.

The non-aqueous organic solvent may serve as a medium for transmitting ions that participate in an electrochemical reaction of the battery.

The non-aqueous organic solvent may include a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, caprolactone, and/or propyl propionate (PP).

The ether-based solvent may include dibutyl ether, tetraglyme, diglyme, dimethoxyethane, 2-methyltetrahydrofuran, 2,5-dimethyltetrahydrofuran, and/or tetrahydrofuran. The ketone-based solvent may include cyclohexanone. The alcohol-based solvent may include ethyl alcohol and/or isopropyl alcohol. The aprotic solvent may include nitriles such as R-CN (where R is a hydrocarbon group having a C2 to C20 linear, branched, or cyclic structure and may include a double bond, an aromatic ring, or an ether group); amides such as dimethylformamide; dioxolanes such as 1,3-dioxolane and/or 1,4-dioxolane; and/or sulfolanes.

The non-aqueous organic solvent may be used alone or in a mixture of two or more thereof.

In addition, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a rechargeable lithium battery and plays a role in enabling a basic operation of the rechargeable lithium battery and in promoting the movement of lithium ions between the positive electrode and the negative electrode. The lithium salt may include, for example, at least one selected from among LiPF₆, LiBF₄, LiSbF₆, LiAsF₆, LiClO₄, LiAlO₂, LiAlCl₄, LiPO₂F₂, LiCl, Lil, LiN(SO₃C₂F₅)₂, Li(FSO₂)₂N (lithium bis(fluorosulfonyl)imide, LiFSl), LiC₄F₉SO₃, LiN(CₓF₂ₓ₊₁SO₂)(CyF_{2y+1}SO₂) (where x and y are integers of 1 to 20), lithium trifluoromethane sulfonate, lithium tetrafluoroethanesulfonate, lithium difluoro(oxalato)borate (LiDFOB), lithium difluorobis(oxalato)phosphate (LiDFBOP), and lithium bis(oxalato)borate (LiBOB).

The following will describe in more detail an electrolyte for a rechargeable lithium battery according to one or more embodiments of the present disclosure.

According to one or more embodiments, the electrolyte for a rechargeable lithium battery may include a non-aqueous organic solvent, a lithium salt, and an additive, and the additive may include a compound represented by Chemical Formula 1.

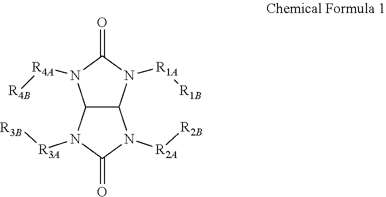

In Chemical Formula 1,

R_{1A}, R_{2A}, R_{3A}, and R_{4A} may each independently be a substituted or unsubstituted C1 to C10 alkylene group, a substituted or unsubstituted C2 to C10 alkenylene group, or a substituted or unsubstituted C2 to C10 alkynylene group.

R_{1B}, R_{2B}, R_{3B}, and R_{4B} may each independently be hydrogen, a substituted or unsubstituted C1 to C10 alkyl group, a substituted or unsubstituted C2 to C10 alkenyl group, or a substituted or unsubstituted C2 to C10 alkynyl group.

At least one selected from among R_{1B}, R_{2B}, R_{3B}, and R_{4B} may include an alkenyl group.

The additive will be further discussed in more detail later.

The electrolyte may be prepared by a mixing process in which the lithium salt is dissolved in the non-aqueous organic solvent and the additive is added to mix. The mixing process of the electrolyte is widely available in the electrolyte fabrication field, and a person skilled in the art will be able to select and use it appropriately or suitably.

In one or more embodiments, the non-aqueous organic solvent may be a mixed solvent of ethylene carbonate (EC), ethylmethyl carbonate (EMC), and dimethyl carbonate (DMC). In other words, a person skilled in the art should readily select and apply the appropriate or suitable mixing method as needed.

The ethylene carbonate (EC) may be included in an amount of about 10 vol % to about 30 vol % relative to (i.e., based on) 100 vol % of a total volume of the non-aqueous organic solvent. The ethylmethyl carbonate (EMC) may be included in an amount of about 20 vol % to about 40 vol % relative to (i.e., based on) 100 vol % of the total volume of the non-aqueous organic solvent. The dimethyl carbonate (DMC) may be included in an amount of about 40 vol % to about 60 vol % relative to (i.e., based on) 100 vol % of the total volume of the non-aqueous organic solvent. For example, in one or more embodiments, the ethylene carbonate (EC) may be included in an amount of about 15 vol % to about 25 vol % relative to (i.e., based on) 100 vol % of the total volume of the non-aqueous organic solvent. The ethylmethyl carbonate (EMC) may be included in an amount of about 25 vol % to about 35 vol % relative to (i.e., based on) 100 vol % of the total volume of the non-aqueous organic solvent. The dimethyl carbonate (DMC) may be included in an amount of about 45 vol % to about 55 vol % relative to (i.e., based on) 100 vol % of the total volume of the non-aqueous organic solvent.

The ethylene carbonate (EC), ethylmethyl carbonate (EMC), and dimethyl carbonate (DMC) may have a volume ratio of 1:a:b (i.e., the volume ratio of EC:EMC:DMC is about 1:a:b), The “a” may be 1 to 2, and the “b” may be 2 to 3. If (e.g., when) the type (kind) and the volume ratio of the organic solvents are satisfied, the additive may appropriately or suitably maintain its solubility in the non-aqueous organic solvent. The embodiments above, however, are merely examples, and embodiments of the present disclosure are not limited thereto.

In one or more embodiments, the lithium salt may include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSl), LiC₄F₉SO₃, LiN(CxF₂x+₁SO₂)(CyF₂y+₁SO₂) (where x and y are integers of 1 to 20), lithium trifluoromethane sulfonate, lithium tetrafluoroethanesulfonate, lithium difluoro(oxalato)borate (LiDFOB), lithium difluorobis(oxalato)phosphate (LiDFBOP), and lithium bis(oxalato) borate (LiBOB).

The lithium salt may have a concentration of about 0.1 M to about 2.0 M. For example, in one or more embodiments, the lithium salt may have a concentration of equal to or greater than about 0.5 M or equal to or greater than about 1.0 M. The lithium salt may have a concentration of equal to or less than about 2.0 M, equal to or less than about 1.7 M, or equal to or less than about 1.5 M. If (e.g., when) the lithium salt has a concentration of about 0.1 M to about 2.0 M, the electrolyte may appropriately or suitably maintain its conductivity and viscosity.

### Additive

The additive according to disclosure may include a compound represented by Chemical Formula 1.

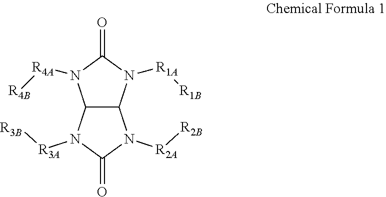

In Chemical Formula 1,

R_{1A}, R_{2A}, R_{3A}, and R_{4A} may each independently be a substituted or unsubstituted C1 to C10 alkylene group, a substituted or unsubstituted C2 to C10 alkenylene group, or a substituted or unsubstituted C2 to C10 alkynylene group.

R_{1B}, R_{2B}, R_{3B}, and R_{4B} may each independently be hydrogen, a substituted or unsubstituted C1 to C10 alkyl group, a substituted or unsubstituted C2 to C10 alkenyl group, or a substituted or unsubstituted C2 to C10 alkynyl group.

At least one selected from among R_{1B}, R_{2B}, R_{3B}, and R_{4B} may include an alkenyl group.

In one or more embodiments, R_{1A}, R_{2A}, RBA, and R_{4A} may each independently be a substituted or unsubstituted C1 to C5 alkylene group, a substituted or unsubstituted C2 to C5 alkenylene group, or a substituted or unsubstituted C2 to C5 alkynylene group. For example, in one or more embodiments, R_{1A}, R_{2A}, R_{3A}, and R_{4A} may each independently be a substituted or unsubstituted C1 to C5 alkylene group.

In one or more embodiments, R_{1B}, R_{2B}, R_{3B}, and R_{4B} may each independently be hydrogen, a substituted or unsubstituted C1 to C5 alkyl group, a substituted or unsubstituted C2 to C5 alkenyl group, or a substituted or unsubstituted C2 to C5 alkynyl group. For example, in one or more embodiments, R_{1B}, R_{2B}, R_{3B}, and R_{4B} may each independently be a substituted or unsubstituted C2 to C5 alkenyl group.

In one or more embodiments, at least two selected from among R_{1B}, R_{2B}, R_{3B}, and R_{4B} may include an alkenyl group. In one or more embodiments, at least three selected from among R_{1B}, R_{2B}, R_{3B}, and R_{4B} may include an alkenyl group. In one or more embodiments, R_{1B}, R_{2B}, R_{3B}, and R_{4B} may each include an alkenyl group.

In one or more embodiments, Chemical Formula 1 may be Chemical Formula 2. For example, the additive according to one or more embodiments of the present disclosure may include a compound represented by Chemical Formula 2.

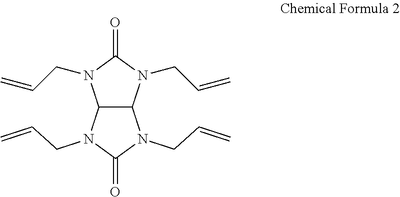 [SMILES: C=CCN1C(=O)N(CC=C)C2C1N(CC=C)C(=O)N2CC=C]

The additive may be present in an amount of about 0.01 wt % to about 10 wt % relative to (i.e., based on) 100 wt % of a total weight of the electrolyte for a rechargeable lithium battery. In one or more embodiments, the additive may be present in an amount of about 2 wt % to about 7 wt % relative to (i.e., based on) 100 wt % of the total weight of the electrolyte for a rechargeable lithium battery. In one or more embodiments, the additive may be present in an amount of about 0.05 wt % to about 5 wt % relative to (i.e., based on) 100 wt % of the total weight of the electrolyte for a rechargeable lithium battery. An amount of the additive may refer to a weight of the additive included in the electrolyte relative to the total weight of the electrolyte. If (e.g., when) the additive is present in an amount within the range above, it may maximize or increase an effect on improving battery performance at high temperatures.

The compound represented by Chemical Formula 1 may have a structure that includes “a pentagonal ring moiety including nitrogen” and “a terminal alkenyl moiety.”

The “pentagonal ring moiety including nitrogen” as used herein may refer to a pentagonal ring (i.e., five-membered ring) moiety including “nitrogen-carbonyl group-nitrogen” as a part of the ring. The compound may include two fused “pentagonal ring moieties including nitrogen,” for example, a glycoluril moiety. Nitrogen included in the pentagonal ring moiety may stabilize the positive electrode by bonding with a metal ion of a positive electrode active material on a surface of the positive electrode. This may delay and alleviate degradation of the surface of the positive electrode and improve battery performance.

The “terminal alkenyl moiety” may refer to an alkenyl moiety positioned at a terminal portion of the compound of Chemical Formula 1. The terminal portion of the compound may denote R_{1B}, R_{2B}, R_{3B}, and R_{4B}. The alkenyl group may be, for example, a vinyl group, a propenyl group, or an isopropenyl group. For example, in one or more embodiments, the “terminal alkenyl moiety” may be a vinyl group. The compound may include at least one “terminal alkenyl group.” For example, in one or more embodiments, the compound may include four “terminal alkenyl moieties.” The compound may participate in the formation of a solid electrolyte interface (SEI) on a surface of a negative electrode, thereby improving stability of the SEI. As the alkenyl moiety is structurally positioned at a terminal portion of the compound, a reaction for stabilizing the SEI may occur more easily.

The two fused “pentagonal ring moiety including nitrogen” are symmetrically connected to form a glycoluril moiety, the “terminal alkenyl moieties” included in the compound may be positioned adjacent to each other. Thus, a cascade of reaction for stabilizing the SEI may be induced. The effect of the compound on improving battery performance may be stably and synergistically achieved.

In other words, the compound represented by Chemical Formula 1 features a structure that includes a pentagonal ring moiety with nitrogen and a terminal alkenyl moiety. The pentagonal ring moiety, which may include nitrogen elements bonded with carbonyl groups, can stabilize the positive electrode by bonding with metal ions, thereby improving battery performance. The terminal alkenyl moiety, such as a vinyl or propenyl group, is positioned at the terminal portion of the compound and aids in forming a solid electrolyte interface SEI on the negative electrode, enhancing its stability. The compound may include two fused pentagonal ring moieties forming a glycoluril moiety, with terminal alkenyl moieties positioned adjacent to each other, facilitating a cascade of reactions that stabilize the solid electrolyte interface SEI and synergistically improve battery performance.

Because the compound represented by Chemical Formula 1 has the aforementioned structural features, the additive according to the present disclosure may have an excellent or suitable effect on improving battery performance during activation (e.g., charging) of rechargeable lithium batteries by stabilizing the SEI of the negative electrode. The effect may be more excellent or suitable in reducing gas generation and lengthening storage at high (or elevated) temperatures. The high (or elevated) temperatures may refer to equal to or greater than about 40° C., equal to or greater than about 50° C., or equal to or greater than about 60° C.

The additive according to one or more embodiments of the present disclosure may further include one or both (e.g., simultaneously) of vinylene carbonate (VC) and vinyl ethylene carbonate (VEC) in addition to the compound represented by Chemical Formula 1. If (e.g., when) the additive includes one or both (e.g., simultaneously) of vinylene carbonate (VC) and vinyl ethylene carbonate (VEC), each of the vinylene carbonate (VC) and the vinyl ethylene carbonate (VEC) may be included independently in an amount of about 0.01 wt % to about 3 wt % relative to (i.e., based on) 100 wt % of the total weight of the electrolyte. The one or both (e.g., simultaneously) of vinylene carbonate (VC) and vinyl ethylene carbonate (VEC) may react with the compound represented by Chemical Formula 1, thereby forming a stable solid electrolyte interface (SEI) on the surface of the negative electrode.

### Rechargeable Lithium Battery

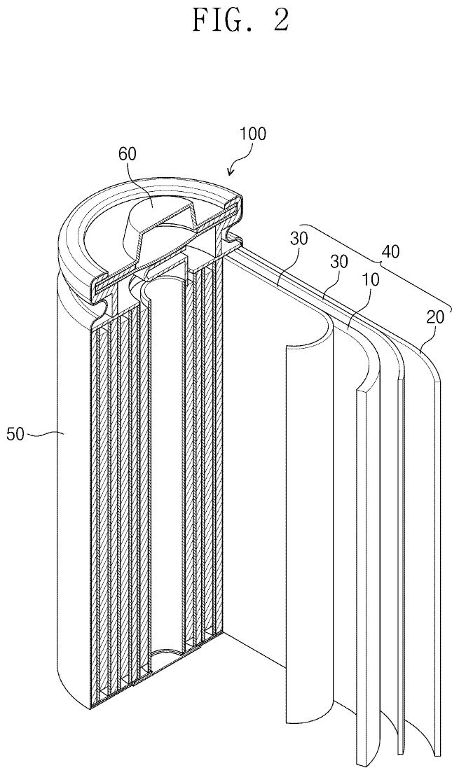

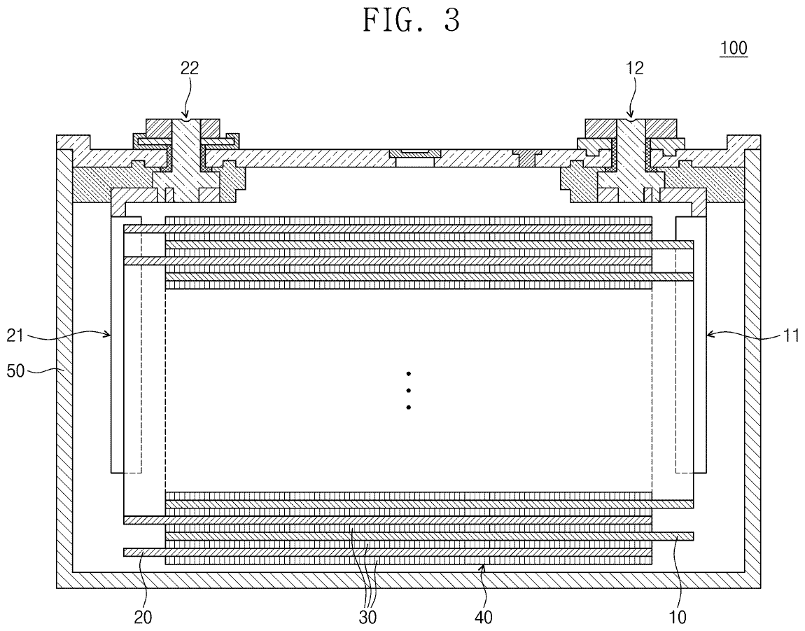

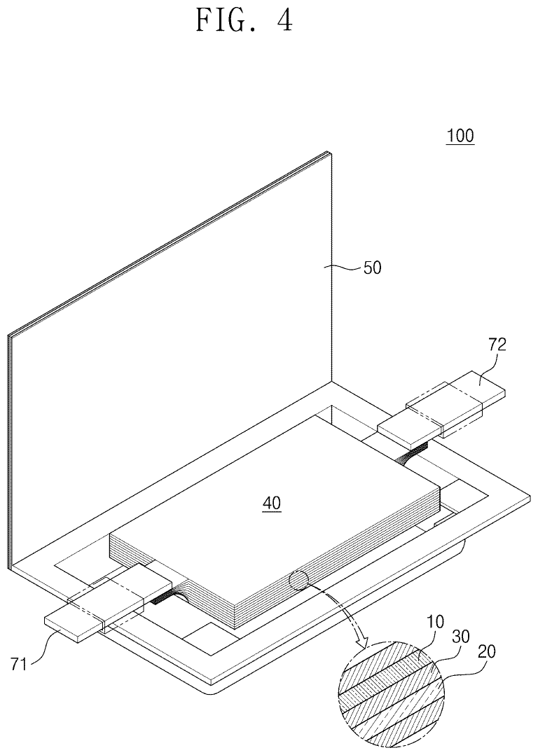

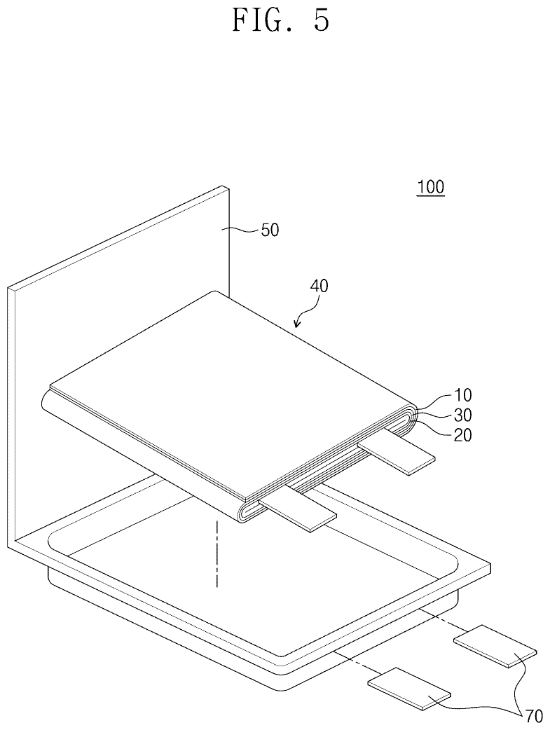

Based on a shape of a rechargeable lithium battery, the rechargeable lithium battery may be classified into a cylindrical, prismatic, pouch, or coin type (kind). FIGS. 2 to 5 each illustrate a simplified diagram showing a rechargeable lithium battery according to one or more embodiments of the present disclosure, with FIG. 2 showing a cylindrical battery, FIG. 3 showing a prismatic battery, and FIGS. 4 and 5 each showing a pouch-type (kind) battery. Referring to FIGS. 2 to 5, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in and/or with an electrolyte. In one or more embodiments, the rechargeable lithium battery 100 may include a sealing member 60 that seals the casing 50 as illustrated in FIG. 2. In one or more embodiments, as illustrated in FIG. 3, the rechargeable lithium battery 100 may include a positive electrode lead tab 11, a positive electrode terminal 12, a negative electrode lead tab 21, and a negative electrode terminal 22. In one or more embodiments, as shown in FIGS. 4 and 5, the rechargeable lithium battery 100 may include an electrode tab 70, or a positive electrode tab 71 and a negative electrode tab 72, which serves as an electrical path for inducing a current generated in the electrode assembly 40 to the outside.

The rechargeable lithium battery according to one or more embodiments of the present disclosure may be applied to automotive vehicles, mobile phones, and/or any other electrical devices, but embodiments of the present disclosure are not limited thereto.

The rechargeable lithium battery according to one or more embodiments of the present disclosure may include a positive electrode including a positive electrode active material, a negative electrode including a negative electrode active material, and the aforementioned electrolyte for a rechargeable lithium battery.

The positive electrode active material may include a lithium composite oxide represented by Chemical Formula 3:

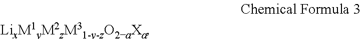

wherein 0.5≤x≤1.8, 0≤a≤0.05, 0<y≤1, 0≤z≤1, and 0≤y+z≤1,

M¹, M², and M³ may each independently include at least one element selected from among metals such as Ni, Co, Mn, Al, B, Ba, Ca, Ce, Cr, Fe, Mo, Nb, Si, Sr, Mg, Ti, V, W, Zr, La, and/or a (e.g., any suitable) combination thereof, and X may include at least one element selected from among F, S, P, and Cl.

In one or more embodiments, in Chemical Formula 3, M¹ may be Ni. In one or more embodiments, in Chemical Formula 3, M¹ may be Ni, M² may be Co, and M³ may be Al. In one or more embodiments, the positive electrode active material may include a nickel-cobalt-aluminum (NCA)-based positive electrode active material.

Inherent instability of Ni may cause a significant side reaction between a positive electrode active material containing Ni and an electrolyte. Therefore, the battery stabilization effect of the additive according to the present disclosure may be more pronounced in the positive electrode active material.

The negative electrode active material may be a carbon-based negative electrode active material, a Si-based negative electrode active material, a Sn-based negative electrode active material, and/or a (e.g., any suitable) combination thereof.

The following will describe several example embodiments and comparative examples of the disclosure. The following embodiments, however, are merely examples, and the present disclosure is not limited to the example embodiments discussed herein.

### SYNTHESIS EXAMPLE 1

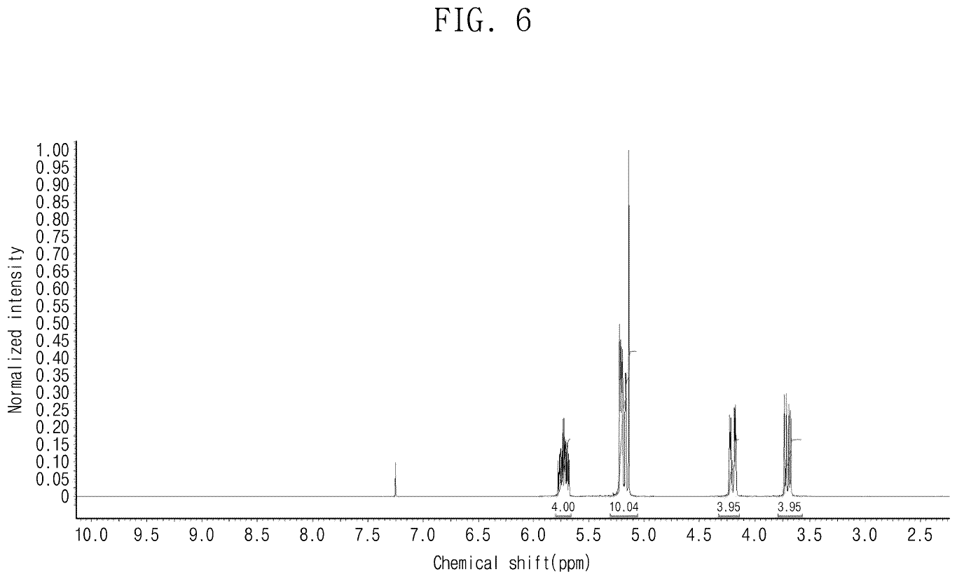

After glycoluril, allyl chloride, and sodium hydroxide were mixed in a molar ratio of 1:4:5 in dimethyl sulfoxide and stirred at 50° C. for 2 hour, the mixture was mixed with water and extracted with ethyl acetate, and then an organic layer is collected and then treated with magnesium sulfate and filtered. The filtered filtrate was concentrated and dried with a vacuum pump to obtain a compound represented by Chemical Formula 2. The compound of Chemical Formula 2 was confirmed by the proton nuclear magnetic resonance (¹H-NMR) spectroscopy as shown in FIG. 6.

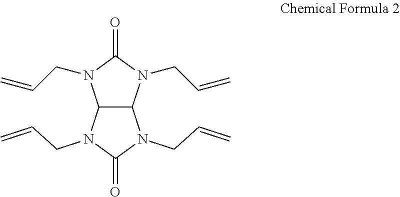 [SMILES: C=CCN1C(=O)N(CC=C)C2C1N(CC=C)C(=O)N2CC=C]

SYNTHESIS EXAMPLE 2

A compound represented by Chemical Formula 4 was obtained in substantially the same manner as in Synthesis Example 1, except that 4-chloro-1-butene was used in place of allyl chloride.

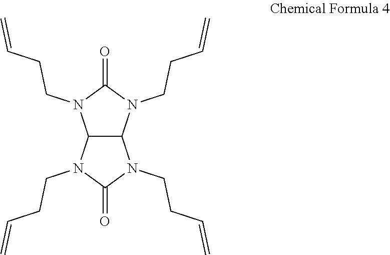 [SMILES: C=CCCN1C(=O)N(CCC=C)C2C1N(CCC=C)C(=O)N2CCC=C]

### Embodiment 1

### (1) Preparation of Electrolyte

1.25 M LiPF₆ was dissolved in a non-aqueous organic solvent containing ethylene carbonate (EC), ethylmethyl carbonate (EMC), and dimethyl carbonate (DMC) mixed in a volume ratio of about 20:30:50. An electrolyte was prepared by adding an additive containing the compound represented by Chemical Formula 2 produced in Synthesis Example 1, vinylene carbonate (VC), and vinyl ethylene carbonate (VEC). The following shows an amount of each compound relative to the total weight of the electrolyte for the rechargeable lithium battery.

Compound represented by Chemical Formula 2:0.25 wt %

Vinylene carbonate (VC): 1.5 wt %

Vinyl ethylene carbonate (VEC): 0.5 wt %

### (2) Fabrication of Rechargeable Lithium Battery

LiNi_{0.91}Co_{0.07}Al_{0.02}O₂ as a positive electrode active material, polyvinylidene fluoride as a binder, and Ketjen black as a conductive material were mixed in a weight ratio of 97:2:1, and the mixture was dispersed in N-methyl pyrrolidone to prepare a positive electrode active material slurry.

The positive electrode active material slurry was coated on an aluminum current collector of 14 micrometers (μm) in thickness, dried at 110° C., and then pressed to manufacture a positive electrode.

Artificial graphite and silicon nano-particles mixed in a weight ratio of 93:7 as a negative electrode active material, styrene butadiene rubber (SBR) as a binder, and carboxymethyl cellulose (CMC) as a thickener were mixed in a weight ratio of 97:1:2, and the mixture was distributed in distilled water to prepare a negative electrode active material slurry.

The negative electrode active material slurry was coated on a copper current collector of 10 μm in thickness, dried at 100° C., and then pressed to manufacture a negative electrode.

The positive electrode, the negative electrode, and a polyethylene separator of 25 μm in thickness were assembled to manufacture an electrode assembly, and the electrolyte was introduced to fabricate a rechargeable lithium battery.

### Embodiment 2

An electrolyte and a rechargeable lithium battery were fabricated in substantially the same method as in Embodiment 1, except that the compound represented by Chemical Formula 2 was utilized in an amount of 0.5 wt %.

### Embodiment 3

An electrolyte and a rechargeable lithium battery were fabricated in substantially the same method as in Embodiment 1, except that the compound represented by Chemical Formula 2 was utilized in an amount of 1.0 wt %.

### Embodiment 4

An electrolyte and a rechargeable lithium battery were fabricated in substantially the same method as in Embodiment 1, except that the compound represented by Chemical Formula 2 was utilized in an amount of 5.0 wt %.

### Embodiment 5

An electrolyte and a rechargeable lithium battery were fabricated in substantially the same method as in Embodiment 1, except that the compound of Synthesis Example 2 was used in place of the compound of Synthesis Example 1.

### Comparative 1

An electrolyte and a rechargeable lithium battery were fabricated in substantially the same method as in Embodiment 1, except that the compound represented by Chemical Formula 2 was not included.

### Evaluation 1: Resistance Increase Rate at High-Temperature Storage

Each of the rechargeable lithium batteries fabricated in Embodiments and Comparative was charged at 25° C. with 0.33 C-rate and 4.25 V cut-off, and an initial battery resistance value and a battery resistance value after being left for 60 days at 55° C. were measured. A resistance increase rate was measured and the result is listed in Table 1. The resistance values were measured by using electrochemical impedance spectroscopy (EIS).

The resistance increase rate was calculated according to Equation 1, and the result is listed in Table 1.

$$Resistance increase rate ( \% ) = ( battery resistance after 60 days / initial battery resistance ) \times 100 \qquad Equation 1$$

### Evaluation Example 2: Gas Generation at High-Temperature Storage

Each of the rechargeable lithium batteries fabricated in Embodiments and Comparative was charged at 25° C. with 4.25 V cut-off, left for 60 days at 55° C., and then a thickness was measured to indicate an amount/degree of gas generation. The result is listed in Table 1.

TABLE 1

| | | | | Evaluation result | | |
|---|---|---|---|---|---|---|
| | | | | | Resis- | |
| | Composition of additive | | | | tance | |
| | VC | VEC | Chemical | Chemical | increase | Thick- |
| | amount | amount | Formula 2 | Formula 4 | rate | ness |
| | (wt %) | (wt %) | (wt %) | (wt %) | (%) | (mm) |
| Embodi- | 1.5 | 0.5 | 0.25 | 0 | 116.8 | 14.97 |
| ment | | | | | | |
| 1 | | | | | | |
| Embodi- | 1.5 | 0.5 | 0.5 | 0 | 119.2 | 15.24 |
| ment | | | | | | |
| 2 | | | | | | |
| Embodi- | 1.5 | 0.5 | 1 | 0 | 121.1 | 15.76 |
| ment | | | | | | |
| 3 | | | | | | |
| Embodi- | 1.5 | 0.5 | 5 | 0 | 122.4 | 16.02 |
| ment | | | | | | |
| 4 | | | | | | |
| Embodi- | 1.5 | 0.5 | 0 | 0.25 | 120.7 | 15.49 |
| ment | | | | | | |
| 5 | | | | | | |
| Compar- | 1.5 | 0.5 | 0 | 0 | 130.1 | 16.92 |
| ative | | | | | | |
| 1 | | | | | | |

Referring to Table 1, it may be observed that, compared to Comparative 1, each of the example Embodiments according to the disclosure has a reduced degree of gas generation as indicated by a smaller battery thickness and a decreased resistance increase rate. Thus, it may be ascertained that the additive according to the present disclosure has an excellent or suitable effect on improving battery performance at high temperatures.

The additive according to one or more embodiments of disclosure may have an excellent or suitable effect on improving battery performance at high temperatures.

A rechargeable lithium battery including the additive may exhibit superior and desired performance at high temperatures.

In the present disclosure, expressions such as “at least one of,” “one of,” and “selected from,” when preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. The “/” utilized herein may be interpreted as “and” or as “or” depending on the situation.

In the context of the present disclosure and unless otherwise defined, the terms “use,” “using,” and “used” may be considered synonymous with the terms “utilize,” “utilizing,” and “utilized,” respectively.

In present disclosure, The term “Group” as utilized herein refers to a group of the Periodic Table of Elements according to the 1 to 18 grouping system of the International Union of Pure and Applied Chemistry (“IUPAC”).

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A battery manufacturing device, a battery management system (BMS) device, and/or any other relevant devices or components according to embodiments of the present invention described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

While this disclosure has been described in connection with what is presently considered to be example embodiments, it is to be understood that the present disclosure is not limited to the disclosed embodiments and is intended to cover one or more suitable modifications and equivalent arrangements included within the spirit and scope of the appended claims and equivalents thereof, and therefore the aforementioned embodiments should be understood to be exemplarily but not limiting this disclosure in any way.

What is claimed is:

1. An electrolyte, comprising:
a non-aqueous organic solvent;
a lithium salt; and
an additive,
wherein the additive comprises a compound represented by Chemical Formula 1, 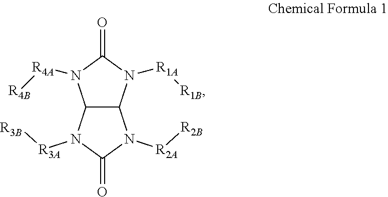
in Chemical Formula 1,
R_{1A}, R_{2A}, R_{3A}, and R_{4A} being each independently a substituted or unsubstituted C1 to C10 alkylene group, a substituted or unsubstituted C2 to C10 alkenylene group, or a substituted or unsubstituted C2 to C10 alkynylene group,
R_{1B}, R_{2B}, R_{3B}, and R_{4B} being each independently hydrogen, a substituted or unsubstituted C1 to C10 alkyl group, a substituted or unsubstituted C2 to C10 alkenyl group, or a substituted or unsubstituted C2 to C10 alkynyl group, and
at least one selected from among R_{1B}, R_{2B}, R_{3B}, and R_{4B} comprising an alkenyl group, and
wherein the electrolyte is for a rechargeable lithium battery.

2. The electrolyte as claimed in claim 1, wherein R_{1A}, R_{2A}, R_{3A}, and R_{4A} are each independently a substituted or unsubstituted C1 to C5 alkylene group, a substituted or unsubstituted C2 to C5 alkenylene group, or a substituted or unsubstituted C2 to C5 alkynylene group.

3. The electrolyte as claimed in claim 2, wherein R_{1A}, R_{2A}, R_{3A}, and R_{4A} are each independently a substituted or unsubstituted C1 to C5 alkylene group.

4. The electrolyte as claimed in claim 1, wherein R_{1B}, R_{2B}, R_{3B}, and R_{4B} are each independently hydrogen, a substituted or unsubstituted C1 to C5 alkyl group, a substituted or unsubstituted C2 to C5 alkenyl group, or a substituted or unsubstituted C2 to C5 alkynyl group.

5. The electrolyte as claimed in claim 4, wherein R_{1B}, R_{2B}, R_{3B}, and R_{4B} are each independently a substituted or unsubstituted C2 to C5 alkenyl group.

6. The electrolyte as claimed in claim 1, wherein at least two selected from among R_{1B}, R_{2B}, R_{3B}, and R_{4B} comprise an alkenyl group.

7. The electrolyte as claimed in claim 1, wherein at least three selected from among R_{1B}, R_{2B}, R_{3B}, and R_{4B} comprise an alkenyl group.

8. The electrolyte as claimed in claim 1, wherein R_{1B}, R_{2B}, R_{3B}, and R_{4B} each comprise an alkenyl group.

9. The electrolyte as claimed in claim 1, wherein the additive is in an amount of about 0.01 wt % to about 10 wt % based on 100 wt % of a total weight of the electrolyte.

10. The electrolyte as claimed in claim 1, wherein the additive is in an amount of about 0.05 wt % to about 5 wt % based on 100 wt % of a total weight of the electrolyte.

11. The electrolyte as claimed in claim 1, wherein the non-aqueous organic solvent comprises ethylene carbonate, ethylmethyl carbonate, and dimethyl carbonate.

12. The electrolyte as claimed in claim 11, wherein the ethylene carbonate, the ethylmethyl carbonate, and the dimethyl carbonate are in a volume ratio of 1:a:b,
wherein a is about 1 to about 2, and
wherein b is about 2 to about 3.

13. The electrolyte as claimed in claim 1, wherein the additive further comprises vinylene carbonate.

14. The electrolyte as claimed in claim 13, wherein the vinylene carbonate (VC) is in an amount of about 0.01 wt % to about 3 wt % based on 100 wt % of a total weight of the electrolyte.

15. A compound represented by Chemical Formula 2,

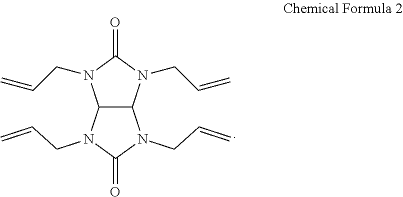 [SMILES: C=CCN1C(=O)N(CC=C)C2C1N(CC=C)C(=O)N2CC=C]

16. A rechargeable lithium battery, comprising:
a positive electrode that comprises a positive electrode active material;
a negative electrode that comprises a negative electrode active material; and
the electrolyte as claimed in claim 1.

17. The rechargeable lithium battery as claimed in claim 16, wherein the positive electrode active material comprises a lithium composite oxide represented by Chemical Formula 3, 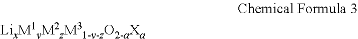
in Chemical Formula 3,
0.5≤x≤1.8, 0≤a≤0.05, 0<y≤1, 0≤z≤1, and 0≤y+z≤1,
M¹, M², and M³ each independently comprising at least one element selected from among Ni, Co, Mn, Al, B, Ba, Ca, Ce, Cr, Fe, Mo, Nb, Si, Sr, Mg, Ti, V, W, Zr, La, and a combination thereof, and
X comprising at least one element selected from among F, S, P, and Cl.

18. The rechargeable lithium battery as claimed in claim 17, wherein, in Chemical Formula 3, M¹ is Ni.

19. The rechargeable lithium battery as claimed in claim 16, wherein the positive electrode active material comprises a nickel-cobalt-aluminum-based positive electrode active material.

20. The rechargeable lithium battery as claimed in claim 16, wherein the negative electrode active material comprises a carbon-based negative electrode active material, a Si-based negative electrode active material, a Sn-based negative electrode active material, or a combination thereof.
